(19) United States
(12) Patent Application Publication
(10) Pub. No.: US 2005/0256682 A1
(43) Pub. Date: Nov. 17, 2005

(54) Method of evaluation of space systems for safety assurance and residual risk to flightcrew

(76) Inventors: Barry Clifford Galutia, Yorba Linda, CA (US); Doug Harold Young, Mammoth, CA (US)

Correspondence Address: STETINA BRUNDA GARRED & BRUCKER, 75 ENTERPRISE, SUITE 250, ALISO VIEJO, CA, 92656, US

(21) Appl. No.: 10/843,042

(22) Filed: May 11, 2004

(51) Int. Cl. F02K 1/00

(52) U.S. Cl. 702/185

(57) ABSTRACT

A process for evaluating space systems for safety assurance and residual risk to the flight crew. The process includes a success oriented System Safety phase which attempts to reduce the probability of failure with respect to the loss of a crew member as low as practical; a failure oriented SPACESAFE phase which assumes that at least one Safety Critical Subsystem has failed and attempts to engineer a risk mitigation design minimize adverse effects on the crew; and an Integration phase which complimentary integrates the System Safety phase with the SPACESAFE phase. Such process allows for increased flight crew safety by minimizing risk of a failures that contribute to loss of a crew member.

### STATEMENT RE: FEDERALLY SPONSORED RESEARCH/DEVELOPMENT

The present invention was developed under U.S. Government Contract No. NAS8-01100

### CROSS-REFERENCE TO RELATED APPLICATIONS

Not Applicable

### BACKGROUND OF THE INVENTION

1. Field of the Invention

The present invention relates to processes used to evaluate manned space systems for safety assurance and residual risk to flight crew. More specifically, the present invention relates to a process which utilizes a success-oriented System Safety process and a complementary failure-oriented approach (a.k.a. SPACESAFE) as a means for improving the survival of astronaut crews in the event of a catastrophic system failure.

2. Background of the Invention

Throughout the history of manned space flight, various safety, quality, and reliability principles expressed in processes, analyses, and/or algorithms have been implemented to increase mission success rate and to ensure the ultimate safety of the flight crew. NASA's reliability record for manned flight mission success (e.g., currently 98.2% for the Space Shuttle Program including the Columbia accident) speaks for itself. However, in light of the Columbia accident, the spirit of continued improvement in providing the safest possible environment for astronauts, and proposed new manned flight programs, there is still a need to refine and/or enhance the current safety, quality, and reliability processes, analyses, and/or algorithms in place to ensure the ultimate in safety of the flight crew.

The traditional System Safety algorithm provides a highest reasonable assurance that a hazardous condition will not occur at a rate higher than that specified either in the contract of or the Statement of Work (SOW). Although the System Safety analysis has proven effective over the years, it does have deficiencies. In particular, since System Safety analysis is success-oriented, it does not provide risk mitigation strategies for cases where a Safety Critical Subsystem (SCS) has indeed failed.

It would be advantageous to provide a new process for evaluating manned space flight systems for safety assurance and residual risk to onsflight crew which includes and considers failure-oriented risk mitigation studies. For instance, it would be beneficial to provide a process which investigates risk mitigation strategies for failures of all safety critical subsystems, not just failures within safety critical subsystems. Ideally, it would be beneficial to provide a process which complements the success-oriented System Safety approach, therefore, providing greater safety coverage of potential hazardous outcomes from use of the manned flight space system.

### BRIEF SUMMARY OF THE INVENTION

The present invention provides a means for improving the survival rate of astronaut operating crews in the event of a catastrophic subsystem failure. The process is intended to complement other engineering activities (System Safety and Crew Survival), which are also intended to provide safety for the flight crews during nominal and expected flight operations. One aspect of the present invention is that it provides a process which takes a failure-oriented approach towards providing the maximum benefit for crew survival. Furthermore, the present invention is not limited to a specific Safety Critical Subsystem, nor is limited to specified sets of causal factors, nor is limited to the operational system itself.

SPACESAFE provides methods, processes, and algorithms for evaluating space systems for safety assurance and residual risk to personnel, specifically astronauts/flight crew. As previously discussed, the SPACESAFE process operates under the assumption that safety critical subsystems have failed and that catastrophic or critical hazards are imminent. Based on this assumption, design or procedural changes are evaluated to identify the best means for preserving the survival of the flight crew.

SPACESAFE adds a failure-oriented analysis component to the system safety evaluation that seeks to maximize crew safety in the event of catastrophic subsystem failures. Typical system safety efforts and analyses (i.e. prior art) are a success-oriented approaches to the safety assessment of systems, and are limited to specific Safety Critical Subsystem analysis. Wherein the present invention is not limited to a specific Safety Critical Subsystem, nor, is it limited to specified sets of causal factors, such is the case with existing System Safety evaluation techniques. Rather, the SPACESAFE process investigates risk mitigation strategies for failures in all safety critical subsystems, not just single instances.

The SPACESAFE Process is initiated by the identification of the Safety Critical Subsystems on of the space vehicle operating system. These Safety Critical Subsystems will be identified as a normal part of the System Safety process to analyze and assure that required safety assurance levels are met by the total system. The System Safety process will then further decompose the Safety Critical Subsystems to identify all causal factors that can result in hazards to the flight crew and mitigate those causal factors that cause the system to not meet safety assurance levels.

Once the Safety Critical Subsystems have been identified, the SPACESAFE process assumes that these subsystems have failed (e.g., inadvertent operation, failure to operate) in each of the major flight phases of the space vehicle where they are present and can affect crew safety. With the assumption that these subsystems have failed, means for mitigating the hazards effects on the flight crew will be postulated. These risk mitigation strategies may take the form of hardware or software changes and/or procedural modifications. Risk mitigation strategies will also be requested from any member of the contractor design teams and the customer on a non-direction basis. Each of these potential risk mitigation strategies will then be evaluated for quantitative and/or qualitative benefit to the flight crew as well as the costs: factors relating to dollars, schedule, reliability, maintainability, testability, quality, etc. This process will be documented from concept through final disposition with periodic follow up in the SPACESAFE Action Record.

An advantage of the SPACESAFE process is that it offers numerous benefits to the customer. One benefit is an assessment, (not necessarily implementation) of risk strategies which is not confined by cost/schedules constraints. SPACESAFE further provides a deeper look into the effects of hazards (credible/non-credible). Columbia Accident Investigation Board (CAIB) type changes are identified and implemented before a loss occurs. And SPACESAFE provides a documented risk communication method between all parties involved in operating the manned flight space program (e.g., contractors, customers, military and operators).

Other exemplary embodiments and advantages of the present invention may be ascertained by reviewing the present disclosure and the accompanying drawings.

### BRIEF DESCRIPTION OF THE DRAWINGS

The present invention is further described in the detailed description that follows, by reference to the noted drawings by way of non-limiting examples of preferred embodiments of the present invention, in which like reference numerals represent similar parts throughout several views of the drawings, and in which:

FIG. 1 depicts the complimentary aspect of a success-oriented approach and a failure-oriented approach, according to an aspect of the present invention;

FIG. 2 depicts the differences between the System Safety, Crew Survival features and SPACESAFE, according to an aspect of the present invention;

FIG. 3 is a Ven diagram depicting analysis performed to distinguish “reasonable credible hazards” from “credible hazards” in System Safety approaches, according to an aspect of the present invention;

FIG. 4 is a box diagram representative of events space of the possible outcomes from a manned flight mission in which system operation/functionality “succeeds” and “fails” are compared to risk mitigation system “succeeds” and “fails”, according to an aspect of the present invention.

FIG. 5 depicts assignment of the level of risk mitigation of the safety critical subsystems over all operational phases of the mission, according to an aspect of the present invention;

FIG. 6A is a flow diagram of a Primary and/or Independent Safety Assessment, according to an aspect of the present invention;

FIG. 6B depicts the manner in which the Primary Safety Assessment Report and Independent Safety Assessment Report are combined together, according to an aspect of the present invention.

FIG. 7 is a flow diagram of a first embodiment of an exemplary SPACESAFE process in the context of a System Safety Program, according to an aspect of the present invention;

FIG. 8 is a flow diagram of a second embodiment of an exemplary SPACESAFE process in the context of a System Safety Program, according to an aspect of the present invention;

FIG. 9 is a flow diagram of alternative embodiments of various phases of SPACESAFE process, according to an aspect of the present invention;

FIGS. 10A-C provide an exemplary SPACESAFE Action Record form, according to an aspect of the present invention.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

Overview of the Present Invention

The present invention (hereinafter also referred to as “SPACESAFE” methods and processes) provides a process for improving the survival rate of astronaut crews in the event of a catastrophic subsystem failure. The process is intended to complement other engineering activities (System Safety and Crew Survival), which are also intended to provide safety for the flight crews during nominal and expected flight operations.

SPACESAFE operates under the assumption that Safety Critical Subsystems (SCS) have failed (either operation when not warranted or failure to operate when warranted) and that catastrophic or critical hazards are imminent. Based on this assumption, design or procedural changes are evaluated to identify the best means for preserving the survival of the flight crew. The process then seeks to identify means of mitigating risk to the flight crew. Mitigations may take the form of hardware changes/additions, software changes/additions, or procedural changes. The process removes the System Safety emphasis of identifying hazard causal factors, then reducing or eliminating them to preclude or minimize hazard occurrence. Instead, SPACESAFE as a complementary function to the System Safety and Crew Survival functions and focuses on improving the likelihood that space crews are returned safely after a catastrophic event.

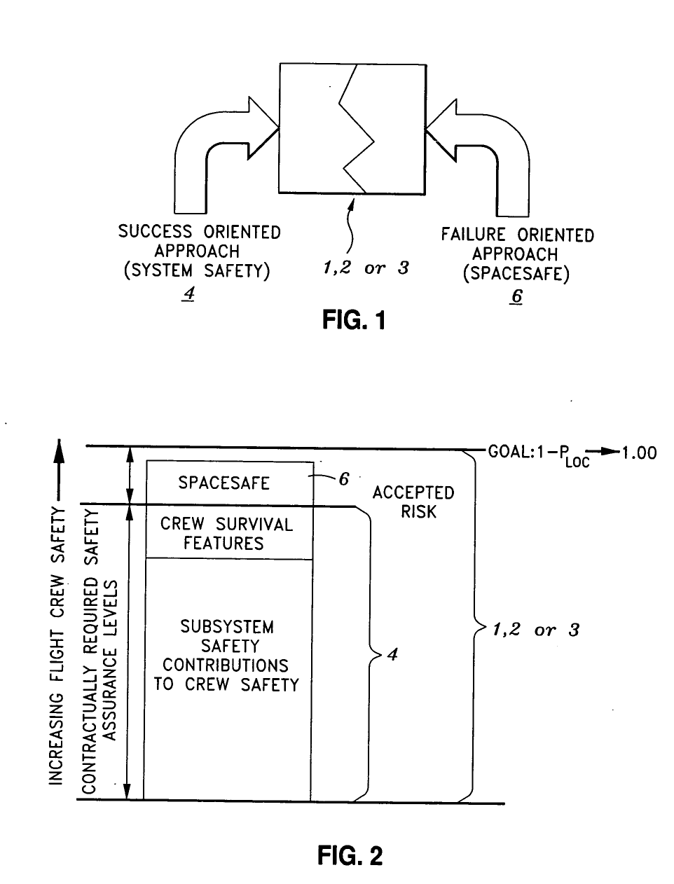

As mentioned, SPACESAFE utilizes a failure-oriented approach to system safety analysis to investigate risk mitigation approaches that may be incorporate to improve flight crew survival. Therefore, one of the aspects of the present invention is that it ecompliments the standard System Safety process and is not intended as a replacement. Thus, as illustrated in FIG. 1, the SPACESAFE process 2 combines a System Safety “success-oriented approach” 4 with a “failure-oriented approach” 6 as is illustrated in FIG. 1. As a result, use of the complimentary success and failure-oriented approaches provides greater probability of crew survival during use of the system.

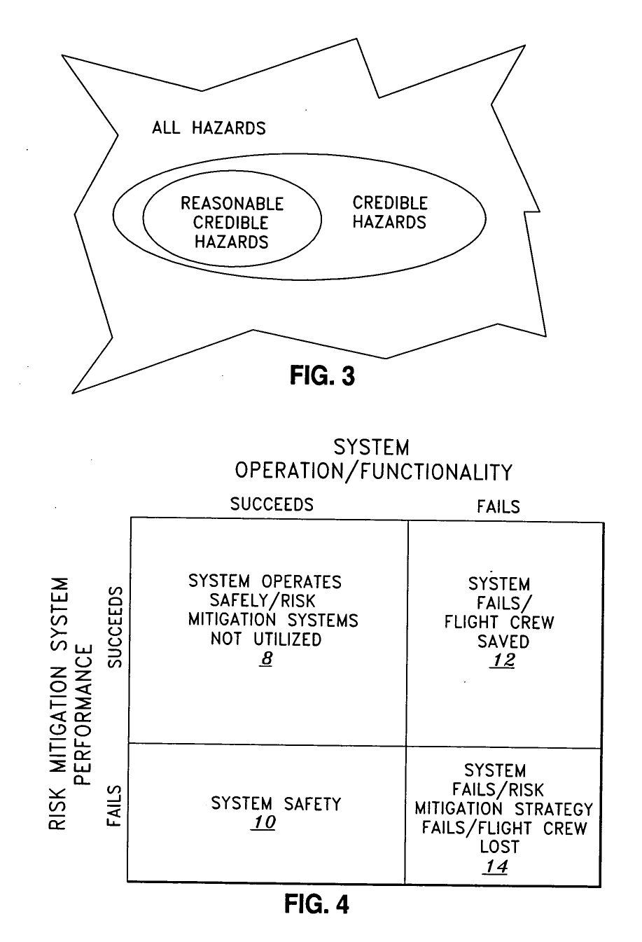

More specifically, the present invention is intended to ecompliment other engineering activities, such as System Safety and Crew Survival, which are also intended to provide safety for the flight crews during nominal and expected flight operations. The differences between the System Safety, Crew Survival features and SPACESAFE are illustrated in FIG. 2. Typically, System Safety dictates contractually required safety assurance levels (i.e., an accepted risk level), which include Subsystem subsystem Safety safety Contributions contributions to Crew Safety and Crew Survival Features, thus resulting in System Safety requirements 4 for flight crews 5. Wherein in an effort to increase flight crew safety, a SPACESAFE complimentary process 6 is added, therefore, resulting in System Safety requirements for flight crews and an additional SPACESAFE safety process for flight crews 2. The ultimate goal of the SPACESAFE process is to provide a manned spaced flight system in which the probability of loss of crew (LOC) more closely approaches zero [GOAL: 1-P_{LOC}=1]. In this regard, the present invention provides additional safety assurance for the flight crew during operations of the space system in the form of any combination of hardware, software, or procedural changes to the system.

Credible and Non-Credible Hazards

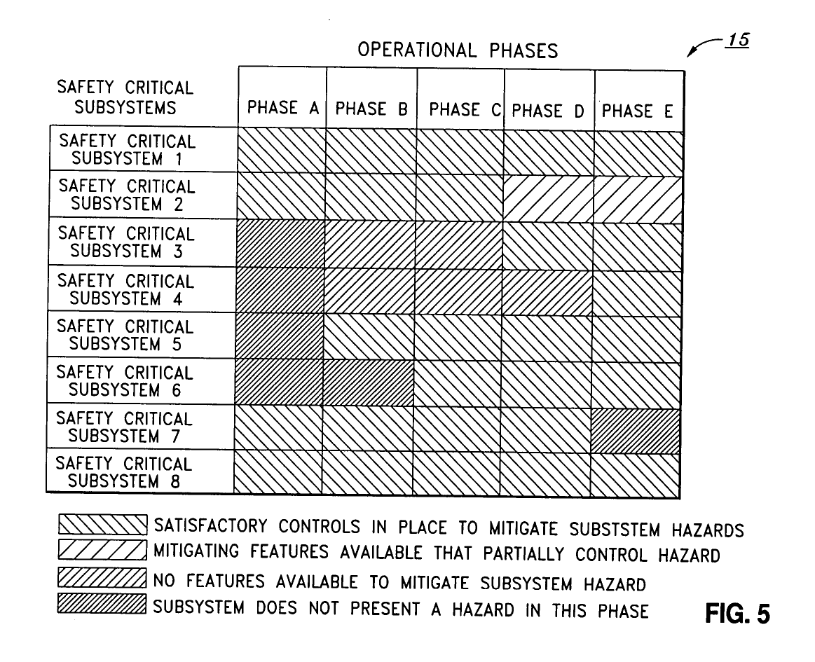

The SPACESAFE process will remove the effort involved in defining “credible failures” for investigation on a program. In the traditional System Safety approach, analysis is performed to distinguish “reasonable credible hazards” from “credible hazards” as is depicted in FIG. 3. In general, System Safety analysis deals primarily with “reasonable, credible failures”.

Credible hazards are defined differently in various NASA specifications. For instance, according to NASA Safety Manual 8715.3, a “Credible Condition (Event)” is defined as a condition (event) that reasonably may be anticipated and planned for based on experience with or analysis of a system. According to KSC Payload Ground Safety Handbook for Space Shuttle, “credible” is a condition that can occur and is reasonably likely to occur. It is further stated in the KSC Payload Ground Safety Handbook for Space Shuttle, that for the purpose of this document, failures of structure, pressure vessels, and pressurized lines and fittings are not considered credible failure modes if those elements comply with the applicable requirements. And, according to International Space Station Requirements Document SSP 50021, a “Credible Failure” is defined as a condition that has a potential of occurring based on actual failure modes in similar systems.

On the other hand, SPACESAFE operates on both credible and non-credible hazards. Assessment of non-credible failures produces fully engineered and priced solutions to mitigate “non-credible” failures. Additionally, credible, but accepted failures by System Safety are re-assessed to produce solutions better than the program specified risk levels by defining fully engineered and price solutions. Another aspect of the SPACESAFE process is that it provides full disclosure of operational risks in the Flight Readiness Review process to all participants. Moreover, the SPACESAFE process may be organizationally placed to avoid conflicts of interest and to encourage full disclosure. Through this change in approach, failures that are deemed not credible may be mitigated and the probability of saving flight crews increases. As an example, until early February 2003, the damage from a foam strike on the Space Shuttle reinforced carbon-carbon panels (RCC) was defined as a non-credible hazard. Foam strikes causing damage to leading edge RCC panels is are now considered a credible hazard.

Event Space for System Functionality versus Risk Mitigation Performance

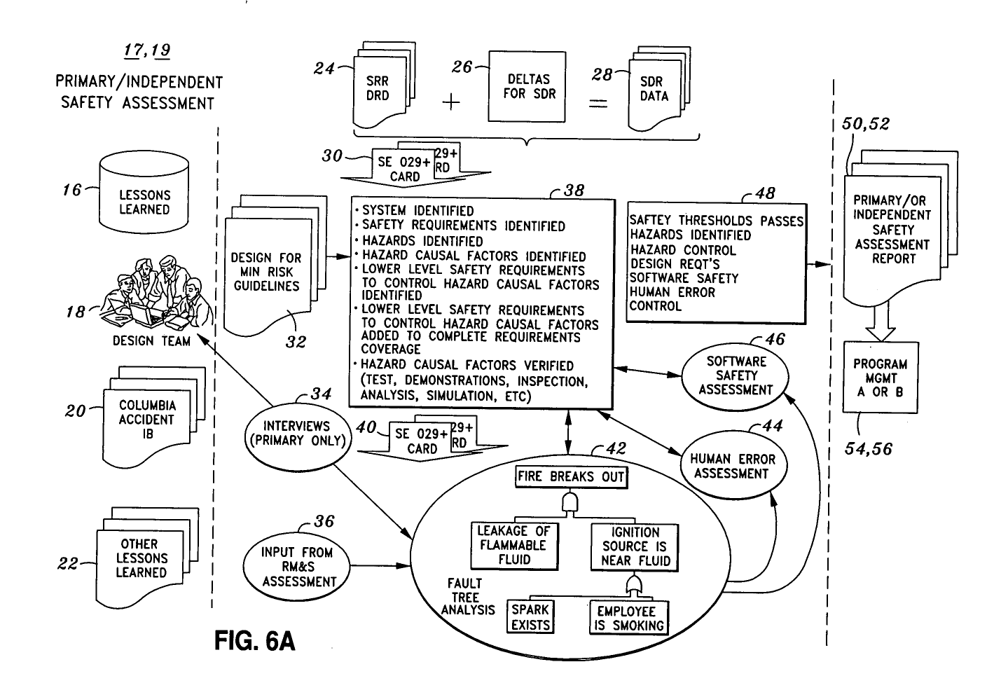

To be able to better appreciate some aspects of the present invention, it is helpful to compare system operation/functionality to risk mitigation system performance. FIG. 4 is a box diagram representative of events space of the possible outcomes from a manned flight mission in which system operation/functionality “succeeds” and “fails” are compared to risk mitigation system “succeeds” and “fails”. In particular, box 8 represents occurrences when the system operates safely and wherein risk mitigation strategies are not utilized. For instance, this box is representative of a successful manned-flight mission having no anomalies. Box 10 indicates a part of the traditional System Safety programs in which risk mitigations are not applicable, nor functional, and both “succeeds” and “fails” are possible. For instance, this box is representative residual risk accepted in a program contract. Box 12 indicates an addition of the failure-oriented approach in which “succeeds” and “fails” are a possibility, and of which an anomaly occurs and wherein a risk mitigation hardware or procedure is in place and is effective. This region is representative of the increase on crew survivability due to SPACESAFE mitigations over a system built to contract and statement of work (SOW), but without the risk mitigation features. For instance, box 12 is representative of instances in which a flight crew would have been considered lost under the success-oriented approach, however, with the implementation of the failure-oriented approach, the lives of the flight crew are saved. Box 14 indicates occurrences in which “fails” are imminent even when both the success-oriented approach and failure-oriented approaches are implemented. In this region, acceptable failure rate for the system is defined in the system contract of the System Safety Program Plan. If an anomaly occurs in box 14, system loss and loss of crew (LOC) occurs.

Summary of the SPACESAFE Process

The SPACESAFE Process is initiated by the identification of the Safety Critical Subsystems (SCS) on the space vehicle. These Safety Critical Subsystems will be identified as a normal part of the System Safety process to analyze and assure that required safety assurance levels are met by the total system. The System Safety process will then further decompose the Safety Critical Subsystems to identify all causal factors that can result in hazards to the flight crew and mitigate those causal factors that cause the system to not meet safety assurance levels.

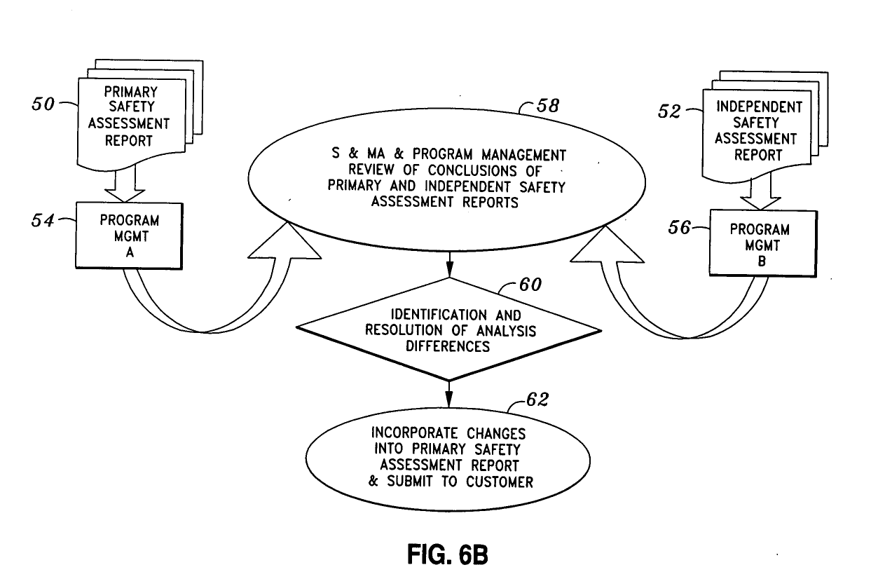

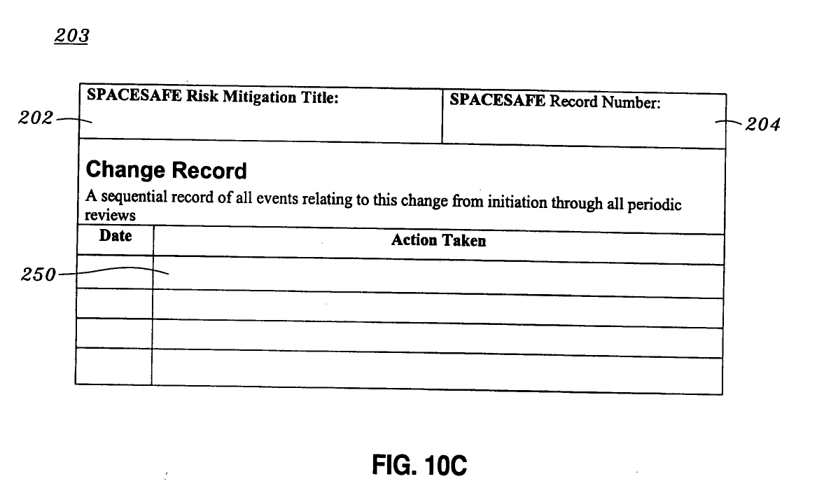

Once the Safety Critical Subsystems have been identified, the SPACESAFE team will assume that these subsystems have failed (inadvertent operation, failure to operate) in each of the major flight phases of the space vehicle where they are present. With the assumption that these subsystems have failed, means for mitigating the hazards effects on the flight crew will be postulated. These risk mitigation strategies may take the form of hardware or software changes and/or procedural modifications. Risk mitigation strategies will also be requested from any member of the contractor design teams and the customer (e.g., NASA) on a non-direction basis. Each of these potential risk mitigation strategies will then be evaluated for quantitative and/or qualitative benefit to the flight crew as well as the costs: factors relating to dollars, schedule, reliability, maintainability, testability, quality, etc. The SPACESAFE process and activities preferably will be documented from concept through final disposition with periodic follow-up in the SPACESAFE Action Record a notational form of which is shown in FIGS. 10A-C. The SPACESAFE Action Record 200 will be discussed in further detail later in the specification. Moreover, a Risk Mitigation Coverage Matrix 15 (see FIG. 5) is also generated which will also be discussed later in the specification.

A SPACESAFE Report will be submitted to the client (e.g. NASA) office outside of the primary vehicle program management and to the contractor program management team simultaneously for review and consideration. The SPACESAFE Report will include at least the SPACESAFE Action Record 200 and the Risk Mitigation Coverage Matrix 15.

The results of the SPACESAFE evaluation preferably will be maintained as a living document with periodic status update submittals. At defined time intervals, each SPACESAFE risk mitigation strategy will be reviewed. The SPACESAFE changes that have been implemented will be reviewed for efficacy and how well the implementation followed predicted cost and schedule. Those SPACESAFE risk mitigations that were not chosen for incorporation due to low expected crew benefit, lack of technology, etc. will be re-evaluated to determine whether or not those conditions that made the risk mitigation unacceptable have changed to a point where incorporation is feasible.

Since the proposed risk mitigations of the SPACESAFE process will be to improve crew safety above and beyond the contractually required safety assurance levels required by the contract, decisions to incorporate SPACESAFE risk mitigation strategies will need to be approved for funding by the customer (e.g., NASA).

Documentation of the SPACESAFE evaluation results, in conjunction with the results of System Hazard Analyses, will provide the users of the system a full understanding of the safety assurance levels designed into the delivered system and the consideration of further alternative approaches evaluated to reduce the probability of loss of crew.

A First Embodiment of the Process in Context of the System Safety Program

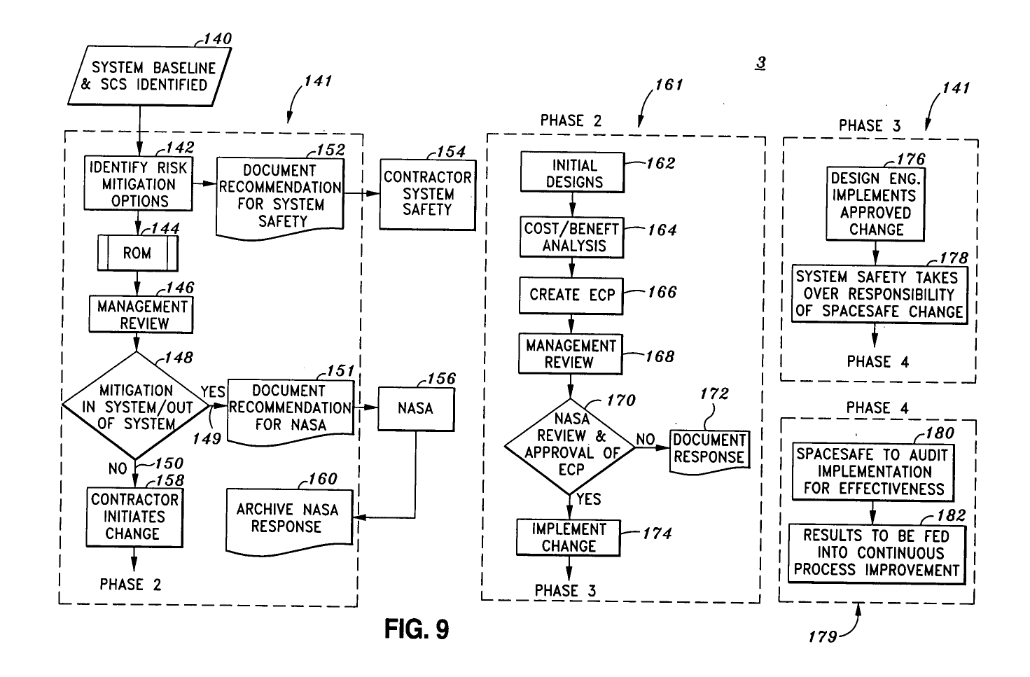

A first exemplary embodiment of the SPACESAFE process 1 is flow diagrammed in FIG. 7. At 70, hazards are identified. At 72, Safety Critical Subsystems are identified. At 74, safety critical failure modes and effects are identified. At this breakpoint, System Safety now proceeds with the assessment of risk at the subsystem level and collects the risk calculation to the top level for determination of contractual or Statement of Work (SOW) compliance and verification of the risk assessment by test. Any verification failures or analytical failures are resolved through design or procedural changes until contract or SOW compliance, at a minimum, is achieved. At 78, risk mitigation strategies are evaluated and ranked, with respect to hardware changes 80, software changes 82, procedural changes 84, and other changes 86. At 88, cost, schedule, and risk reduction benefit [% decrease in probability of loss of crew (PLOC)] are evaluated for each risk mitigation strategy. At 92, results are analyzed and conclusions (in a report that is under configuration control and data management) are reported to program management and the customer's (e.g., NASA) program management at the same time to accurately report findings and resolve any concerns at a high and visible level. This reporting chain is preferably to be different than the reporting chain for the traditional system safety effort and product review. At 90, the implemented risk mitigations strategies and those risk mitigation strategies that were not implemented are periodically monitored and reviewed to determine if the current state of technology will change the conclusions of the trade assessment. The status of the program is then to be reported periodically to management and the customer as defined in the System Safety Program Plan.

A Second Embodiment of a Process in Context of the System Safety Program

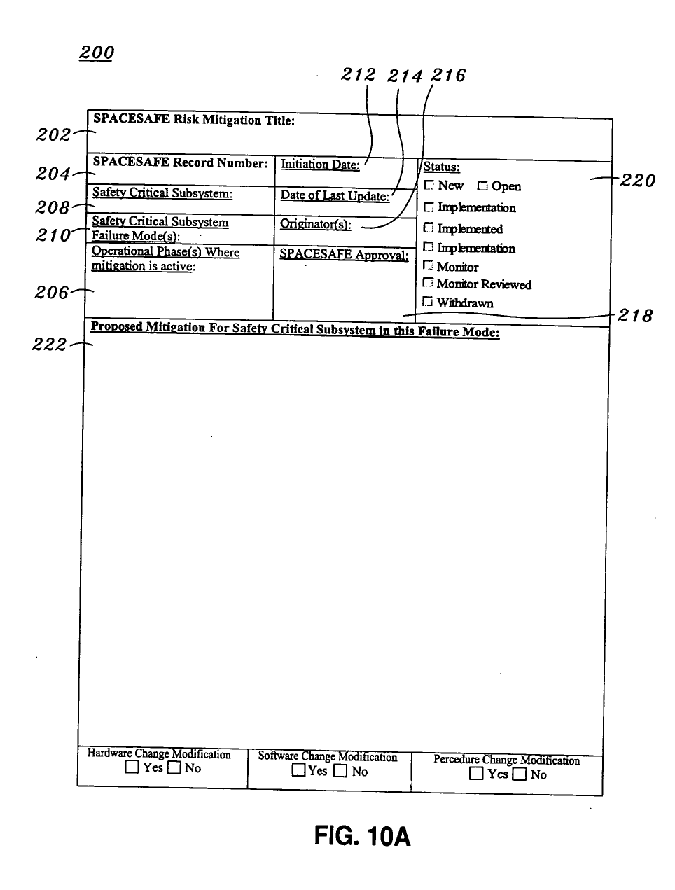

A second exemplary embodiment of the SPACEBASE process 2 is flow diagrammed in FIG. 8. This process 2 may generally be broken down into several sequences/and or phases, including a “System Safety” phase 101, SPACESAFE “Phase 1” 105, and a Integration “Phase 2” 107 which integrates the System Safety phase with SPACESAFE “Phase 1”.

Steps 100 through 109 represent the System Safety sequence 101. It is noted that with the System Safety process, P_{f}, the probability of failure, is made as low as practical. At 100, top level hazards are identified. At 102, Safety Critical Subsystems are identified. At 104, a hazard analysis is performed via a Failure Mode Effect Analysis (FMEA) and/or a Critical Items List. At 106, it is determined whether the hazard analysis from 104 is an acceptable risk for the system? If no at 108, nominal iterative design and operations are considered at 116. If yes at 109, document safety assessment reports are prepared at 116.

“Phase 1” 105 of the SPACESAFE process is initiated at 103 between steps 102 and 104. It is noted that SPACESAFE starts with a Safety Critical Subsystem (SCS) probability of failure P_{f}=1, which assumes a failure has occurred. At 122, options to save the flight crew in the event of an SCS failure are identified. At 124, a cost benefit analysis is performed. At 126, prioritization is performed by maximum benefit versus cost. At 128, a SPACESAFE Report is prepared and documented.

The Integration “Phase 2” 107 of the SPACESAFE process 2 includes the steps which integrate the System Safety sequence 101 with the SPACESAFE “Phase 1” 105. In particular, if at 106, the hazard analysis reveals an acceptable risk at 109, then at 110 a Safety Assessment Report is prepared and documented. At 112, the impact on the Safety Assessment Report is assessed. At 114, system safety monitoring of system performance is implemented. At 118, an Engineering Change Proposal (ECP) is created a sent to an Engineering Review Board (ERB) and a Prime Review Board (PRB). At 120, ERB/PRB decisions are made. The decisions from 120 are then included in the SPACESAFE Report at 128. Moreover, at 130, there are periodic re-evaluations of the SPACESAFE findings. At 132, the SPACESAFE Report is submitted to a safety oversight team. At 134, the SPACESAFE Report is submitted to OSP Program Management. Then at 136, SPACESAFE trade studies are performed.

A Third Embodiment of a Process in Context of the System Safety Program

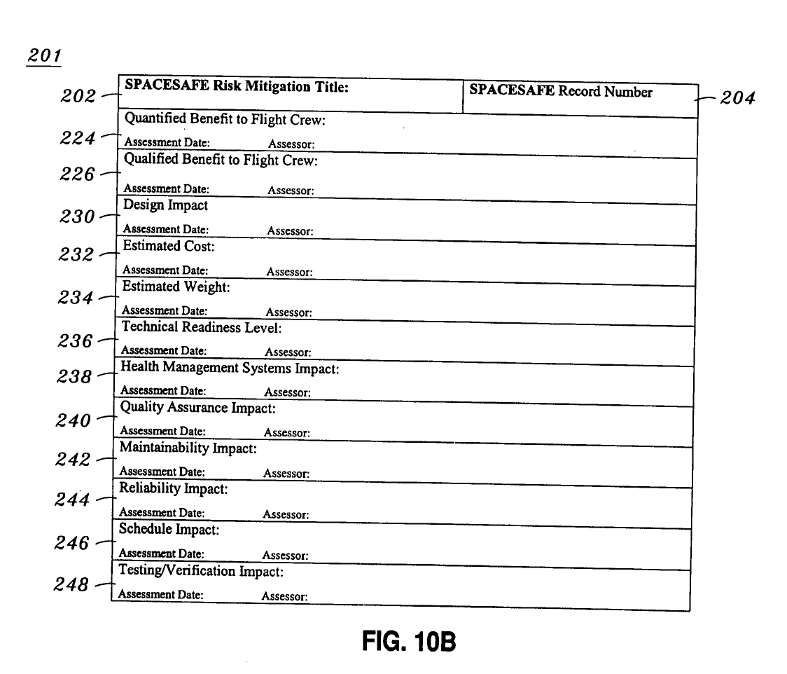

A third exemplary embodiment of the SPACEBASE process 3 is flow diagrammed in FIG. 9. This process 3 may generally be broken down into various sequences/and or phases, including “Phase 1” at 141, “Phase 2” at 161, Phase 3” at 175, and “Phase 4” at 179.

Before “Phase 1” at 141 is initiated, at 140 the system is baselined and Safety Critical Subsystems (SCS) are identified. Here the SCS list is received from the System Safety function. Moreover, it is assumed the probability of failure, P_{f}=1 for Safety Critical Subsystems. It is noted that the analysis is performed on each SCS. Once the system is baselined and SCS are identified, Phase 1 is initiated at 142.

At 142 risk mitigation options are identified. Here, brainstorming occurs, including structured discussion with discipline experts sufficient to address the loss of SCS functionality. Also, discipline experts outside the program design influence are selected (in cooperation with program discipline experts) to increase independence of decision. Also, methods are proposed to eliminate the source of the hazard. And, proposed “how to” recommendations are sent back to System Safety.

At 152 recommendations for System Safety are documented, and routed to Contractor System Safety at 154. At 144, ROM (rough order of magnitude) parametric cost estimate is developed. At 146, management review is implemented. For instance, this may include a SPACESAFE manager and contractor program manager.

At 148, it is determined whether mitigation is performed in or out of the system. If the mitigation is within the system at 149, a quick-turn around change may be recommended under a threshold to be determined under the program. At 151, the recommendation is documented for the customer (e.g., NASA). For instance, the recommendation is documented on a SPACESAFE Action Record (see FIGS. 10A-C) and submitted to the SPACESAFE customer element for further review. At 156, the customer (e.g., NASA) receives the recommendations and at 160, the customer's response is archived. It is noted that at this point in the Phase 1, management rejection of a recommended change is absolutely acceptable (due to adverse schedule, cost, or other factors that are part of the contract) and is not to be perceived as a negative factor. If at 148 the mitigation is out of the system at 150, then at 158 the contractor may initiate a change.

“Phase 2” 161 is initiated at 162 where initial designs are considered. At 164, a cost benefit analysis is performed. At 166, an Engineering Change Proposal (ECP) is created. At 168, management review is performed with SPACESAFE and program management. The customer (e.g., NASA) then submits the ECP. At 170, the customer (e.g., NASA) performs a review of the SPACESAFE implementation package. Here the customer reviews the ECP. If the ECP is not approved, at 172 the response is documented and maintained in data management control. If the ECP is approved, the proposed change is implemented at 174.

In “Phase 3” 175, design engineering implements the approved change. At this stage, System Safety takes over responsibility of the SPACESAFE change within the context of the system. In “Phase 4” 179, the SPACESAFE management audits SPACESAFE design implementation for effectiveness and assess actual costs versus estimated costs. Further, the results are then to be fed into a Continuous Improvement Process.

Additionally, periodic review is to be performed. In particular, the SPACESAFE process periodically re-evaluates the previous SPACESAFE recommendations to identify if any criteria that caused a rejection has changed such that it is no longer a cause for rejection. The report re-evaluation is then to be submitted to the Customer. Moreover, a SPACESAFE flight readiness review data package is prepared. In the package, changes that were implemented are provided and risk improvement is provided in the package. Also, changes that have been rejected, and approved changes yet to be incorporated/residual risk are provided in the package.

Primary and Independent Safety Assessment

Another aspect of the present invention is an independent safety assessment which is conducted in a bifurcated manner. Two safety assessments are performed by separate parties independent of each other, including (1) a Primary Safety Assessment, and (2) an Independent Safety Assessment.

In general, a complete System Safety assessment is performed based upon the design schematics, functional flow diagrams, system operations concepts documents, etc. No direct contact with the design team, or, the System Safety team performing the Primary Safety Assessment should be allowed. Hazard analysis results are to be reported via a separate management path from the Primary Safety Assessment with notification of the Customer. Review of hazard analysis products and comparison with the primary hazard analysis results will be performed in an open forum with configuration and data managed control of all findings of differences in the hazard analysis reports. Each difference will be investigated by two separate teams to identify the causes of the differing conclusions and corrective actions reports will be documented to modify the safety processes to correct any errors identified. Corrections and updates will be incorporated into a Primary Safety Assessment document.

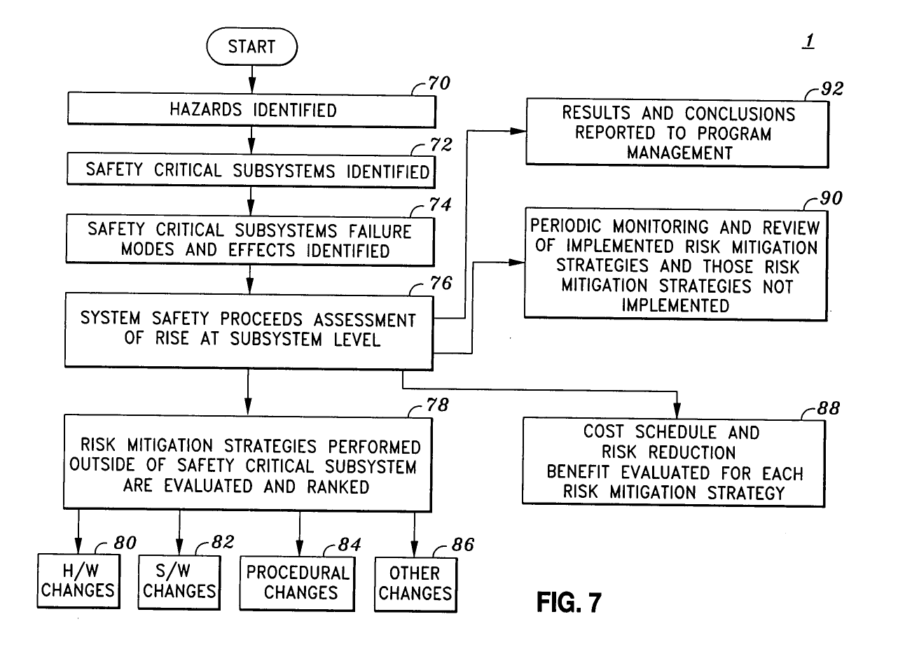

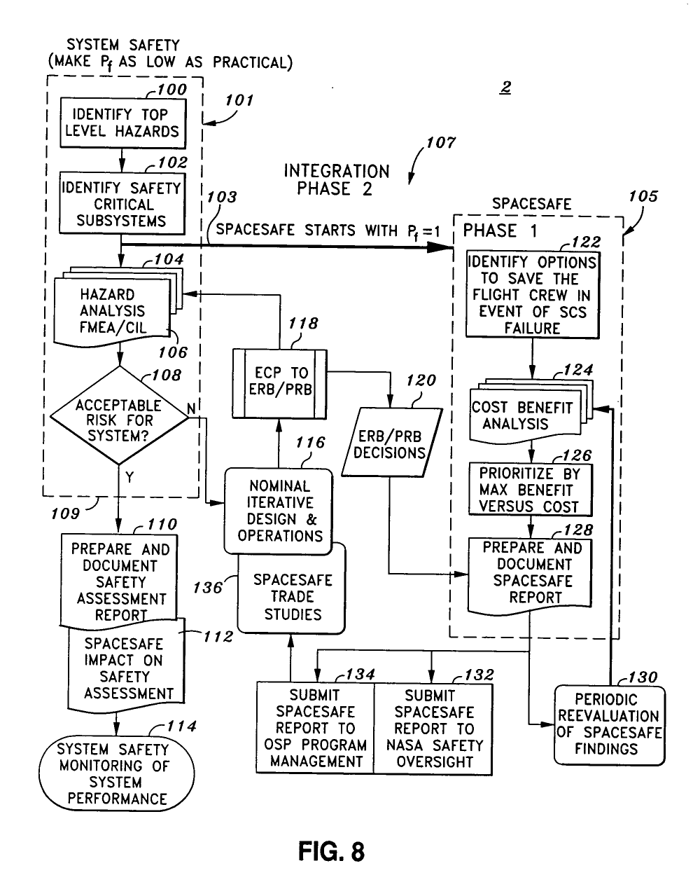

An exemplary safety assessment flow diagram which may be used for both the Primary (17) and Independent (19) Safety Assessment is depicted in FIG. 6A. Lessons learned by the customer are compiled at 16, 18, 20, 22. At 34, interviews are held for the Primary Safety Assessment 17, however, interviews are not held for the Independent Safety Assessment 19. At 24, System Requirement Revisions (SRR) and Data Requirement Descriptions (DRD) are added at 26 to deltas for System Description Revisions (SDR) and at 28 equivalent SDR Data is the result. At 30, System Engineering 029+ Cost Analysis Requirements Descriptions (s)CARDS are compiled. At 32, guidelines for designs with minimum risk are provided. At 38, systems are identified, safety requirements are identified, hazards are identified, hazard causal factors are identified, lower level safety requirements to control hazard causal are added to complete requirements coverage, and hazard causal factor controls are verified (including tests, demonstrations, inspection, analysis, simulation, etc.). At 40, System Engineering 029+ CARDS are compiled. At 36, input from RM&S Assessments are complied. At 42, fault tree analyses are performed for various scenarios. At 44, human error assessments are performed. At 46, software safety assessments are performed. At 48, safety threshold passes, hazards identified, hazard controls, design requirements, software safety, and human error control assessments are compiled. At 50, a Primary Safety Assessment Report 50 and/or an Independent Safety Report 52 is independently compiled and reported to a Primary Program Management Team A (54) or an Independent Management Team B (52), respectively.

FIG. 6B depicts the manner in which the Primary Safety Assessment Report 50 and Independent Safety Assessment Report 52 are combined together, according to an aspect of the present invention. In particular, at 54 the Program Management Team A (54) delivers the Primary Safety Assessment Report (50) to Safety & Mission Assurance and to program management at 58. Also, at 52 the Program Management Team A (56) delivers the Independent Safety Assessment Report (52) to Safety & Mission Assurance (S&MA) and to program management at 58. At 58, S&MA and program management review the conclusions of the Primary and Independent Safety Assessment Reports 50, 52. At 60, the differences between the Primary and Independent Safety Assessment Reports 50, 52 are identified and resolved. At 62, changes are incorporated into the Primary Safety Assessment Report 62 and submitted to the customer.

System Level Risk Mitigation Coverage

Another aspect of the SPACESAFE process is the assignment of the level of risk mitigation of the Safety Critical Subsystems (SCS) over all operational phases of the mission. For each major flight phase, the risk mitigation strategies for each Safety Critical Subsystem will be ranked by greatest benefit to mitigation of crew loss followed by practicality (technology readiness level of proposed solution) and then by cost (dollars, additional complexity, weight, etc.). A SPACESAFE Risk Mitigation Coverage Matrix 15 to show the coverage of the SPACESAFE evaluation and implementation activities over the system is included in the SPACESAFE report. The SPACESAFE Risk Mitigation Coverage Matrix 15 is depicted in FIG. 5.

FIG. 5 provides a matrix 15 which identifies numerous phases in a mission (Phases A-E). Moreover, the Safety Critical Subsystems of the space flight system are listed (Safety Critical Subsystems 1-8). A scale of system level risk is then developed. In the example provided in FIG. 5, the scale includes four levels. One level indicates that satisfactory controls are in place to mitigate subsystem hazards. Another level indicates that mitigating features are available that partially control hazards. Another level indicates that no features are available to mitigate subsystem hazards. A fourth level indicates that a subsystem does not present a hazard in this place. Each phase of the mission and each safety critical subsystems then evaluated and assigned a system level risk.

SPA CESAFE Action Record

One aspect of the present invention is the documentation of actions taken. To accomplish this aspect, a SPACESAFE Action Record 200 form is utilized during the process. The SPACESAFE Action Record 200 is shown in FIGS. 10A-C. The SPACESAFE process will be documented from concept through final disposition with periodic follow up in the SPACESAFE Action Record 200. The following section will now describe the record field descriptions of the SPACE SAFE Action Record 200.

FIG. 10A depicts a first portion of the SPACESAFE Action Record 200. At 202, a box is provided recording the SPACESAFE Risk Mitigation Title. At 204, the SPACESAFE Record Number is recorded which may include three characters for the subsystem, three to seven characters for failure mode, and four digits for sequential numbering. For example: GNC-FTOPER-0001 would be recorded for the anomaly “Guidance, Navigation, & Control, Failure to Operate”. At 206, operation phase(s) are noted where mitigation is active. In particular, this box records major operational phase or phases where a plan for mitigation for the Safety Critical Subsystem failure to operate or inadvertent operation is being evaluated. At 208, the Safety Critical Subsystem that is being evaluated for a risk mitigation is identified. At the Safety Critical Subsystem Failure Mode(s) box 210, a listing of the specific failure modes of the Safety Critical Subsystem that risk mitigations are being evaluated is identified At the Initiation Date box 212, the date of origination of the specific risk mitigation strategy is documented. At the Date of Last Update box 214, the date of the latest modification or other review of the instant specific SPACESAFE record is recorded. At the Originator(s) box 216, originators of risk mitigation strategy are identified. In the SPACESAFE Approval box 218, the signature of the SPACESAFE Lead who has approved this strategy for further evaluation is provided. This is a filtering step in the process. The SPACESAFE risk reduction will be open to any and all persons on the contractor and customer teams. This step is to ensure that the basic idea behind the SPACESAFE process is understood, that the risk mitigation idea makes sense with respect to the hazard, and that no unnecessary records are continuously tracked under this program.

The Status box 220 indicates the point where the action record is in the SPACESAFE process. If “New” is checked, this indicates SPACESAFE risk mitigation strategies that have not yet been submitted to management or the customer. If “Open” is checked, this indicates SPACESAFE risk mitigation strategies that are in progress towards an evaluation position. If “Monitor” is checked, this indicates SPACESAFE risk mitigation strategies that have been evaluated and found to not provide enough benefit versus cost. An update of the evaluation to may be performed periodically to determine whether some of the input criteria have changed that will in turn change the overall benefit/cost assessment. If “Implementation” is checked, this indicates SPACESAFE risk mitigation strategies that have been approved for incorporation into the space system by either program management or the Customer. If “Implemented” is checked, this indicates SPACESAFE risk mitigations that have been implemented into the space system. If “Implemented Reviewed” is checked, this indicates SPACESAFE risk mitigations that have been implemented into the space system and that have been reviewed to identify any areas of the risk mitigation evaluation that did not agree with the actual values for benefit and cost. And, if “Withdrawn” is checked, this indicates removal as an active SPACESAFE record based upon further review that determines the risk mitigation strategy does not makes sense against the subsystem and/or failure mode. Additionally, at 222 a large box for Proposed Mitigation For Safety Critical Subsystem in this Failure Mode is provided. This includes a description of the risk mitigation strategy proposed for implementation on the space system.

FIG. 10B depicts a second portion 201 of the SPACESAFE Action Record 200. Another SPACESAFE Risk Mitigation Title box is provided at 202. Also, another SPACESAFE Record Number box is provided at 204. In the Quantified Benefit to Flight Crew box 224, a quantification, in terms of Probability of Loss of Crew (PLOC), that the proposed change will have for the flight crews of the space system is provided. In the Qualified Benefit to Flight Crew box 226, a qualification, in terms of Probability of Loss of Crew (PLOC), that the proposed change will have for the flight crews of the space system is provided. At the Design Impact box 230, any positive or negative impacts of the proposed change to the design Integrated Product Teams (IPTs) are annotated. The design IPTs affected are to either write or concur with the text of this field. In the Estimated Cost box 232, any positive or negative cost ($) impacts of the proposed change to the space system are documented. The business team is to either write or concur with the text of this field. At the Estimated Weight box 234, any positive or negative impacts of the proposed change to the weight of the space system are recorded. The weights IPT are to either write or concur with the text of this field. In the Technical Readiness Level (TRL) box 236, the technical readiness level of the materials or systems involved in the proposed change is noted. Here the Technical Readiness IPT is to either write or concur with the text of this field. In the Health Management Systems Impact box 238, any positive or negative impacts of the proposed change to the Health Management IPT are annotated. Here the Health Management IPTs affected are to either write or concur with the text of this field. In the Quality Assurance Impact box 240, any positive or negative impacts of the proposed change to the QA IPT are documented. Here, the QA is to either write or concur with the text of this field. In the Maintainability Impact box at 242, any positive or negative impacts of the proposed change to the Maintainability IPT are documented. Here, the Maintainability IPT affected is to either write or concur with the text of this field. In the Reliability Impact box at 244, any positive or negative impacts of the proposed change to the Reliability IPT are recorded. In the box, the Reliability IPT affected is to either write or concur with the text of this field. In the Schedule Impact box 246, any positive or negative impacts of the proposed change to the schedule for vehicle/system delivery are recorded. Here, the Scheduling IPT affected is to either write or concur with the text of this field. In the Testing/Verification Impact box 248, any positive or negative impacts of the proposed change to the Test/Verification IPT is annotated. Here, the Test/Verification IPT affected is to either write or concur with the text of this field.

FIG. 10C depicts a third portion 203 of the SPACESAFE Action Record 200. Another SPACESAFE Risk Mitigation Title box is provided at 202. Also, another SPACESAFE Record number box is provided at 204. In the Change Record box at 250, a listing in chronological order all events relating to this proposed risk mitigation strategy is provided. The listing includes, but is not limited to design reviews, materials evaluation, sample testing, mock-ups, management review, customer reviews, benefit/cost reviews/investigations, follow up re-evaluations (for both incorporated changes and changes deemed presently unacceptable), test results, references to drawing change notices, etc.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and such uses are within the scope of the appended claims.

1. A process for evaluating space systems for safety assurance and residual risk to the flight crew, the process comprising:
identifying hazards;
identifying Safety Critical Subsystems;
identifying Safety Critical Subsystems failure modes and effects;
proceeding with assessment of risk at subsystem level;
collecting risk calculation to a top level for determination of contractual or statement of work compliance and verification of assessment of risk by test, and
resolving verification failures or analytical failures through design or procedural changes until contract or statement of work compliance at a minimum is achieved.

2. The process for evaluating space systems according to claim 1, further comprising,
evaluating and ranking risk mitigation strategies performed outside of Safety Critical Subsystems of interest;
evaluating cost, schedule and risk reduction benefit for the risk mitigation strategies;
reporting results and conclusions to program management and to a customer program management concurrently;
periodically monitoring and reviewing implemented risk mitigation strategies and risk mitigation strategies that were not implemented to determine if the current state of technology will change the conclusions of a trade assessment; and
reporting status of the process periodically to program management and the customer as defined by a System Safety program plan.

3. The process for evaluating space systems according to claim 2, wherein evaluating and ranking risk mitigation strategies performed outside of Safety Critical Subsystems of interest considers hardware, software, and procedural changes.

4. A process for evaluating space systems for safety assurance and residual risk to the flight crew, the process comprising:
a success oriented System Safety phase which sets the probability of failure with respect to the loss of a crew member as low as practical;
a failure oriented SPACESAFE phase which assumes that at least one Safety Critical Subsystem has failed; and
an Integration phase which complimentary integrates the System Safety phase with the SPACESAFE phase;
wherein flight crew safety is increased by minimizing accepted risk of a failure with respect to loss of a crew member.

5. The process for evaluating space systems according to claim 2, wherein the System Safety phase includes identifying top level hazards, identifying Safety Critical Subsystems, performing hazard analysis FMEA's and CIL's, and determining whether a resultant risk is acceptable for each Safety Critical Subsystem.

6. The process for evaluating space systems according to claim 2, wherein the SPACESAFE phase includes identifying options to save the flight crew in event of a Safety Critical Subsystem failure, performing a cost benefit analysis, prioritizing options by maximum benefit versus cost, a preparing and documenting a SPACESAFE Report.

7. The process for evaluating space systems according to claim 5, wherein if it is determined that the resultant risk is acceptable for the Safety Critical Subsystem, then preparing and documenting a safety assessment report, determining an impact that safety assessment report, implementing a System Safety monitoring of the Safety Critical Subsystem.

8. The process for evaluating space systems according to claim 5, wherein if it is determined that the resultant risk is not acceptable for the Safety Critical Subsystem, then nominal iterative design and operations is performed, an Engineering Change Proposal is created a sent to an Engineering Review Board (ERB) and a Prime Review Board (PRB) are decisions are made by both board as to approval or non-approval, and input into the SPACESAFE report.

9. The process for evaluating space systems according to claim 6, further including periodically re-evaluating the findings of the SPACESAFE Report.

10. The process for evaluating space systems according to claim 6, further including submitting the SPACESAFE report to a customer oversight committee and OSP program management.

11. The process for evaluating space systems according to claim 6, further including SPACESAFE trade studies.

12. A process for evaluating space systems for safety assurance and residual risk to the flight crew, the process including a first phase including, performing a system baseline and identifying Safety Critical Subsystems;
identifying risk mitigations options;
documenting recommendations for System Safety;
performing a rough order of magnitude parametric cost estimate;
performing a management review; and
determining whether a mitigation is in or out of the identified Safety Critical Subsystem, wherein if the mitigation is in the Safety Critical Subsystem, the recommendation is documented for a customer and the customer's response is archived, or if the mitigation is not in the Safety Critical Subsystem, a contractor initiates a SPACESAFE change.

13. The process for evaluating space systems according to claim 13, further including a second phase including, preparing initial designs;
performing a cost/benefit analysis;
creating an Engineering Change Proposal;
performing a management review;
submitting the Engineering Change Proposal to the customer for review and approval, wherein the SPACESAFE change is implemented is the change is approved or if the change is not approved, the response of the customer is documented.

14. The process for evaluating space systems according to claim 13, further including a third phase including,
design engineering implementing the approved SPACESAFE change, and
System Safety taking over responsibility of the SPACESAFE change.

15. The process for evaluating space systems according to claim 13, further including a fourth phase including,
auditing the implemented SPACESAFE change for effectiveness; and
feeding the results into a continuous improvement process.
